(19) United States
(12) Patent Application Publication
(10) Pub. No.: US 2023/0390645 A1
(43) Pub. Date: Dec. 7, 2023

(54) PLAYER-CREATED TASKS WITH PERSISTENT COMMUNITY SCORE IN A VIRTUAL ENVIRONMENT

(71) Applicant: Build a Rocket Boy Games Ltd., Edinburgh (GB)

(72) Inventor: Leslie Peter Benzies, Edinburgh (GB)

(21) Appl. No.: 18/330,080

(22) Filed: Jun. 6, 2023

Related U.S. Application Data
(60) Provisional application No. 63/349,507, filed on Jun. 6, 2022.
(60) Provisional application No. 63/349,511, filed on Jun. 6, 2022.

(51) Int. Cl. A63F 13/63; A63F 13/798

(52) U.S. Cl. CPC A63F 13/63; A63F 13/798

(57) ABSTRACT

The present disclosure relates to a system for selecting an individual to accomplish a task within a three-dimensional environment. The system accepts the creation of a task on behalf of a user within the three-dimensional environment from. The task includes a reward to be provided within the three-dimensional environment. The computer also receives and stores the task to a database of available tasks within the three-dimensional environment, transmits a listing of a plurality of potential task candidates to the client computing device, the listing of the plurality of potential task candidates who have offered to accomplish the task and at least one community score for each of the plurality of potential task candidates, and receives a selection of the individual from the plurality of potential task candidates from the client computing device, the selection at least in part reliant upon the at least one community score.

### RELATED APPLICATION INFORMATION

This patent claims priority from U.S. provisional patent application No. 63/349,507 entitled “PERSISTENT COMMUNITY SCORE IN A PERSISTENT VIRTUAL ENVIRONMENT” filed Jun. 6, 2022, the entire content of which is incorporated herein by reference.

This patent claims priority from U.S. provisional patent application No. 63/349,511 entitled “PLAYER-CREATED TASKS AND ASSOCIATED IN-GAME OR REAL-WORLD REWARDS” filed Jun. 6, 2022, the entire content of which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to an interactive three-dimensional computer-generated environment and, more particularly, to the selection of individuals to complete player-created tasks reliant upon persistent social scores within the environment.

### Description of the Related Art

In a virtual world or within video games, there exist many forms of quests or tasks that may be accomplished by a player. Traditionally, these types of tasks appear most commonly in role-playing games (RPGs). Early examples are multi-user dungeons (MUDs) where text-based interaction with non-player characters (NPCs) required players to accomplish certain tasks to receive certain rewards or otherwise advance the story. These tasks may be simple, like a fetch quest to obtain an item in another part of a castle or a quest to create a particular meal for an NPC using ingredients nearby.

These types of interactions evolved into more-complex RPGs and other game types. Massively multiplayer online (MMO) games became focused on these types of quests. There, NPCs would offer rewards of items, experience, and story advancement for completing various tasks or quests and handing in certain “items” or otherwise triggering some event to occur. Internally, these types of quests were handled as a series of checkboxes to ensure completion of all required tasks to obtain the reward.

Because these were NPCs, the downside of not completing the task was nothing. It simply meant the player did not complete the task and, therefore, the reward need not be given. The NPC had no need of the 10 rat tails from East Freeport within the game Everquest®. Instead, it was merely a way to engage the player in the story and advance the player's level to a higher level of experience.

In the context of the metaverse, there is a desire to push gaming further toward being more like the real world. In the real world, individuals can be asked to roof a home, prepare a wedding cake, perform a concert, or merely pick up one's dry cleaning. That individual may be paid for that task, or may be otherwise rewarded. In the real world, when those tasks are not accomplished or accomplished poorly, that individual may not be asked to engage in that activity again, the individual may request a refund of any payment already made, and writ large, the individual's reputation for that skill (e.g. roofing, performing a concert, etc.) may be diminished. There are real world places where reports about performance are posted such as Yelp® or in Google® reviews.

In addition, much of the world operates on reputation more generally. A friend may recommend a roofer, a lawyer, an accountant, a plumber, a personal assistant, or a pianist based upon a positive experience with that individual in the past. A professional can develop a reputation for being excellent at their work or doing poor quality work. A person can also simply develop a reputation for being difficult, angry, pouty, flirtatious or happy, alert, positive, and kind. Over time, particularly in relatively small communities, one's reputation tends to precede oneself. People have moved states or countries to escape their negative reputational consequences. Others get by in life based upon a positive reputation.

It has been difficult to translate reputation into an online context. As the metaverse becomes a reality, people will increasingly be interacting with individuals with whom they have no prior involvement and may never see again. As the metaverse merges with reality—e.g. as one's online persona becomes nearly as important as one's real-world persona—reputation for good and for bad will become increasingly important.

Simultaneously, accomplishment of various tasks will be moved from the purview of NPCs to real-world people, within a virtual world, who would like things to be done. A user may wish to have virtual clothing be designed, to have a virtual home or estate built, to gather virtual materials in a particular amount, or to otherwise accomplish tasks on their behalf. It would be beneficial if these in-game avatars were discernibly different from one another in their reputations and if there were a system for differentiating one potential task candidate from another.

### DESCRIPTION OF THE DRAWINGS

FIG. 1 is an overview of a system for player-created tasks with a persistent community score.

FIG. 2 is a block diagram of an exemplary computing device.

FIG. 3 is a functional block diagram of a system for player-created tasks with a persistent community score.

FIG. 4 is an example user interface for a task creation process.

FIG. 5 is an example user interface for a task search process.

FIG. 6 is an example user interface for a task candidate filtering process.

FIG. 7 is an example user interface for a selection of a task candidate.

FIG. 8 is an example user interface for a task completion.

FIG. 9 is an example user interface for candidate community scoring.

FIG. 10 is a flowchart of a process for creation of a new task.

FIG. 11 is flow diagram for a process of selection of a task candidate and completion of the task.

Throughout this description, elements appearing in figures are assigned three-digit reference designators, where the most significant digit is the figure number where the element is introduced and the two least significant digits are specific to the element. An element that is not described in conjunction with a figure may be presumed to have the same characteristics and function as a previously-described element having the same reference designator.

### DETAILED DESCRIPTION

Within the metaverse there may be tasks that players wish to accomplish, but at which they are less-skilled. For example, an individual may desire to have a very beautiful home or shop on their player-owned or player specific land. Additionally, businesses and other entities may wish to create a desirable shop front or marketing location for their content, products, or experiences. There exist ways to pay for services outside of the metaverse—namely, with cash or other currencies. However, the metaverse wishes itself to be a separate life or a fully-independent environment or to integrate reality with a virtual world.

Players who have unfulfilled tasks (and insufficient time or skill to complete the tasks themselves) can benefit from an effective “job board” or recruiting station or task requisition board visible in locations within the metaverse or always visible within menus or other portions of a metaverse experience. On this board, players may place requests and associated in-metaverse rewards. These postings may be thought of in some sense as tasks or quests with a game, but are player-generated, and player-satisfied.

A user may seek to hire a specific user or a user with specific skills and the metaverse may facilitate the screening process (e.g. an in-game “architect” who has created more than 50 residences and has associated positive reviews in the metaverse or a desirable fashion designer who has created 100+ unique fashion designs for client with associated positive reviews). In some cases, a task may be sufficiently generic that having anyone complete the task may be sufficient (e.g. run to this location, wait for a particular event or item, then return with that item, or gather X number of units of something, then return it to me). The tasks, quests or jobs can be very customizable and available for selected users or for anyone to complete.

The user making the request may be involved in the process of approving a given task candidate before a task may be accepted by that other individual, or the process may be automated. The job may be posted, the individual may accept it, complete it, and “turn it in” to the job board itself, with the associated items, rewards or the like being transferred between the parties as facilitated by the system according to the terms of the job as originally posted and accepted. In a sense, the job may be or form a “smart contract” between the two parties. Money (in-metaverse or real-world) may change hands upon completion. Escrow accounts may be used or pre-approved payment methods may enable the transactions to take place.

The job board posting process may be facilitated by pre-set templates for common job types within the metaverse. So, a less tech-savvy user could be empowered to create a relatively typical job for automatic completion by a given job completer. In this way, the job board may become an important aspect of a metaverse economy in a manner somewhat similar to real-world task services and apps. Relevant payment may be payment in-kind (e.g. in-game metaverse objects), cash (in-game or real-world) or cryptocurrencies or NFTs.

In the real world, one can develop a reputation. A person may consistently lie or cheat or be kind and happy. Over time, particularly in close communities (e.g. work, religious communities, sports teams, clubs, schools, etc.) individuals typically develop a reputation that roughly corresponds to their behavior. Sometimes these reputations are not well-earned, but humans are remarkably good at categorizing large data sets and extrapolating for generalizations as a result. Such categorization can result in injustice to some and in some cases, but in general it has served humans well in survival of the species or of a given tribe of humans to categorize individuals based upon their reputation for good or for evil or, more simply, just for their reliability to complete an assigned or requested task.

The potential to develop a “reputation” for whatever behavior has a significant effect on socialization of individuals toward a median of decency. One generally does not want to be known as a liar or a cheat or a murderer or someone who harms others. To a large extent, this is the utilitarian purpose of shame within the social construct of a community or society at large, to generally socialize our youth (and everyone else for that matter) toward a median norm of socially acceptable behavior that is, hopefully, beneficial for the individual and society at large.

In the internet world or the metaverse, everyone has seen how anonymity has significantly skewed this socialization. Individuals can act horribly without any real fear of repercussions due to the anonymity provided by a faceless, nameless username somewhere on the internet. The YouTube® comments section was famous for a long time for its inflammatory rhetoric and responses to video content. YouTube responded by requiring users to link their Gmail or other Google® account to their YouTube account, thereby tying a real person—at least in theory—to the comments. In the last five or six years since, YouTube has become significantly moderated in its comment section, even if it remains somewhat inflammatory.

The same unaccountable situation is possible within the metaverse where a random user may not be able to develop a reputation in the traditional social construct sense. So, within the metaverse it may be beneficial to impose a pseudo reputational score as a proxy for a user's metaverse actions. In this way, new users or someone unacquainted with a particular user may quickly see and ascertain if a given other user is generally reasonable, honest, etc. In the metaverse, presumably reputations for well-known individuals will develop naturally, but day-to-day interactions where a user may routinely “bump into” individuals from different countries and cultures and locations where neither user has seen the other before and may never see them again, such a proxy reputational score may be necessary or helpful to facilitate day to day interactions.

The community score may be implemented in any number of ways. It may simply be an “up” or “down” vote for interactions with a given user. An up or down may be mandatory or may be optional when users' avatars interact or are in close proximity for a set period of time. The vote may be required following sales transactions or trades between users. There are various places where an up or down vote may take place. The aggregate score may be displayed as a percentage of positive votes (e.g. 85% positive) or in a number of similar ways.

There may be protections in place for vote bombing users, whereby a large number of positive or negative interactions may not be added in a short period of time. There may be a requirement that some affirmative interaction must have taken place between users or avatars before any vote can be given about a given user. There may also be other protections and systems that may be used (e.g. a metaverse-wide ranking system, a scale of 1 to 10 for positivity, etc.). There can be many others.

Description of Apparatus

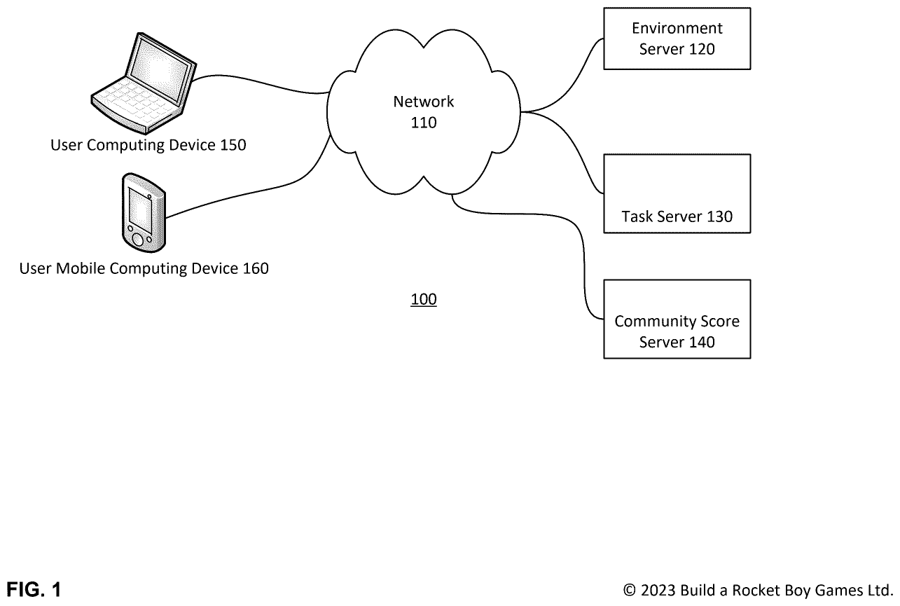

FIG. 1 is an overview of a system for player-created tasks with a persistent community score. The system 100 includes an environment server 120, a task server 130, a community score server 140, a user computing device 150, and a user mobile computing device 160, all interconnected by a network 110.

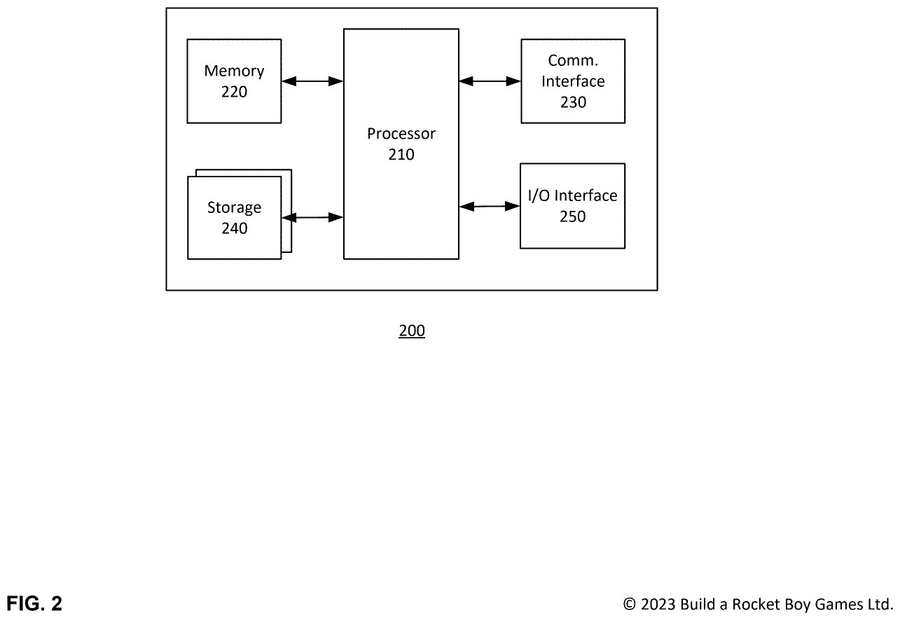

The environment server 120 is a computing device (FIG. 2) or a group of computing devices. The environment server 120 is used to generate a three-dimensional environment into which a plurality of users, using user computing devices like user computing device 150 and user mobile computing device 160, may log to engage with an interactive game or experience. To act as a host or server, the environment server 120 may act as an arbiter of other servers and may maintain the authentication and state information for the overall game or interactive experience hosted by the environment server 120. The environment server 120 may interact with a plurality of other servers or even user computing devices, which may host sub-parts of the overall game or interactive environment.

The environment server 120 may act much like a traditional “game server” to provide a server into which one or more players may log in order to move about in a virtual world comprised of the associated art assets, models and textures. The environment server 120 may primarily operate as an orchestrator of multiple players as they connect and interact with one another, and to ensure integrity of the process of login, and uniformity of the three-dimensional environment (which may actually be rendered locally on each user's machine from a set of game assets and files).

The environment server 120 may be self-hosted, meaning operated by a company or entity that enables the functions and systems described herein. Alternatively, the environment server 120 may be on a shared resource service such as Amazon AWS or Microsoft Azure. Some or all of the environment server 120 may be hosted by the users of the system itself (e.g. a “chat” room made by players) so that users join their computer. In such cases, the environment server 120 or a portion thereof may actually be peer-to-peer hosted by one of the participants and merely orchestrated or controlled by a player.

The task server 130 is a computing device or a group of computing devices. The task server 130 is shown as independent of the environment server 120, but the two servers may be joined or separated, physically, functionally, or logically. The task server 130 is responsible for accepting new tasks input by users of the environment server 120, enabling searching of those tasks by potential task candidates, accepting selections of candidates, facilitating the completion of a task, confirming its completion, and providing a reward to the task completer.

The task server 130 may primarily operate as a database, storing tasks and their various states of completion or non-completion. The task server 130 may also store a history of completed (or not completed) tasks undertaken by users and act as a repository of task history. This history may be used to confirm or provide data and statistics about a given task candidates experiences with similar tasks or different tasks and to store reviews, scores and other information related to tasks.

The community score server 140 is a computing device or a group of computing devices. The task server 130 is shown as independent of the environment server 120 and the task server 140, but the two servers may be joined or separated, physically, functionally, or logically. The community score server 140 may draw upon data stored in the task server 130 or perform or duplicate some of the tasks identified above associated with the task server 130 to capture and store one or more community scores for each user of the environment server.

The “community score” as used herein is an aggregate rating given to a particular user (or user avatar) of the environment server related to a subject by a plurality of other users or people who interact with the user. The subject may be an overall score or a user's general attributes such as the user's demeanor, appearance, attitude, helpfulness, meanness, community-mindedness, etc. The subject may be a specific subject like skill in building digital homes or making digital clothing within the environment generated by the environment server. Just as in the real world, a given artist may be incredibly difficult to deal with but may be a magician in making excellent clothing or building beautiful homes. The subject may be overall reliability (e.g. how often does a given task get completed once undertaken or how long does such work take to complete once undertaken). The subject can be many things, but the subject of the community score is always specific to a given user.

The scores in some sense may be arbitrary. In this specification, the scores are generally discussed as though they were on a scale from zero to one hundred. But, other measures or frameworks could be used. An A+ score could be excellent and an F score could be terrible—matching grading structures in the U.S. Alternatively, a score could simply be a star-rating system which are popular in online forums. A five star rating could be excellent, while a 1 star rating could be terrible. There are various rating systems that may be used for the score, the selection of a particular rating system is not particularly important.

Community scores may be always-visible to other avatars operating in the same space. The community scores may appear as color-coded (e.g. a halo or highlight around a player may indicate a positive—blue—or negative—red—score). The community scores may not appear or be visible at all unless and until a suitable number of scores have been ascertained. So, for example, a minimum of 50 scores may be required for a given overall score or specific score to appear. Input of a community score may be an integral part of interactions with other players. So, whenever one receives in-game “mail” or engages in a purchase or sale or otherwise interacts with another player or avatar, one may be prompted to provide or may spontaneously provide a community score. The process may be as simple as a “thumbs up” or a “thumbs down” process to encourage participation.

The community scores may be in part based upon the users who provide scores to a given user. So, for example, a high community score by another player of a high community score may have more “weight” than that of a new users or a user with a low community score. The environment server may provide community scores for activities deemed to be beneficial to the overall virtual environment. So, for example, donating money to causes within the virtual environment may increase scores automatically (at least to a point). Assisting other players, operating as a moderator or some part of an in-environment government body, operating a storefront, or engaging in other pro-community activities may increase community score. Likewise, repeatedly cursing in chat, attempting to display graphic videos or other content in areas not intended for that conduct, or repeatedly attacking lower-level players (so-called griefing) or being reported as a bad sport in player-versus-player activities may lower community score. Because the virtual environment encompasses many varied experiences, what constitutes positive and negative may be very context specific. The environment software itself may update community scores consistent with the environment in which the activity takes place.

The user computing device 150 is a computing device such as a personal computer, laptop computer, desktop computer or the like. The user computing device 150 may be a typical consumer computing device, lacking in any significant specialized capabilities. However, the user computing device 150 may include a GPU (graphics processing unit) or an integrated GPU (e.g. integrated into a single chip with a CPU). The user computing device 150 is used by a user to connect to the environment server 120 to move an avatar about within a three-dimensional environment generated by the environment server 120 (or, more accurately, on the user computing device 150 as directed by the environment server 120).

The user mobile computing device 160 is effectively identical to the user computing device, though its form factor may be that of a mobile device. It may, for example, be a mobile phone, a smart phone, a tablet computer, or other, similar device. It is shown to indicate that in some cases a user mobile computing device 160 may be used in place of the user computing device 150. In some cases, a virtual reality device or augmented reality device may be used to connect to the environment server using the network 110, much as the user computing device 150 and the user mobile computing device 160.

FIG. 2 is a block diagram of an exemplary computing device 200, which may be or be a part of the environment server 120, the content server 130, the user generated content storage device 140, the user computing device 150, or the mobile computing device 150 of FIG. 1. As shown in FIG. 2, the computing device 200 includes a processor 210, memory 220, a communications interface 230, along with storage 240, and an input/output interface 250. Some of these elements may or may not be present, depending on the implementation. Further, although these elements are shown independently of one another, each may, in some cases, be integrated into another.

The processor 210 may be or include one or more microprocessors, microcontrollers, digital signal processors, application specific integrated circuits (ASICs), or a systems-on-a-chip (SOCs). The memory 220 may include a combination of volatile and/or non-volatile memory including read-only memory (ROM), static, dynamic, and/or magnetoresistive random access memory (SRAM, DRM, MRAM, respectively), and nonvolatile writable memory such as flash memory.

The memory 220 may store software programs and routines for execution by the processor. These stored software programs may include an operating system software. The operating system may include functions to support the input/output interface 250, such as protocol stacks, coding/decoding, compression/decompression, and encryption/decryption. The stored software programs may include an application or “app” to cause the computing device to perform portions of the processes and functions described herein. The word “memory”, as used herein, explicitly excludes propagating waveforms and transitory signals. The application can perform the functions described herein.

The communications interface 230 may include one or more wired interfaces (e.g. a universal serial bus (USB), high definition multimedia interface (HDMI)), one or more connectors for storage devices such as hard disk drives, flash drives, or proprietary storage solutions. The communications interface 230 may also include a cellular telephone network interface, a wireless local area network (LAN) interface, and/or a wireless personal area network (PAN) interface. A cellular telephone network interface may use one or more cellular data protocols. A wireless LAN interface may use the WiFi® wireless communication protocol or another wireless local area network protocol. A wireless PAN interface may use a limited-range wireless communication protocol such as Bluetooth®, Wi-Fi®, ZigBee®, or some other public or proprietary wireless personal area network protocol. The cellular telephone network interface and/or the wireless LAN interface may be used to communicate with devices external to the computing device 200.

The communications interface 230 may include radio-frequency circuits, analog circuits, digital circuits, one or more antennas, and other hardware, firmware, and software necessary for communicating with external devices. The communications interface 230 may include one or more specialized processors to perform functions such as coding/decoding, compression/decompression, and encryption/decryption as necessary for communicating with external devices using selected communications protocols. The communications interface 230 may rely on the processor 210 to perform some or all of these function in whole or in part.

Storage 240 may be or include non-volatile memory such as hard disk drives, flash memory devices designed for long-term storage, writable media, and proprietary storage media designed for long-term storage of data. The word “storage”, as used herein, explicitly excludes propagating waveforms and transitory signals.

The input/output interface 250, may include a display and one or more input devices such as a touch screen, keypad, keyboard, stylus or other input devices. The processes and apparatus may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run an operating system, including, for example, variations of the Linux, Microsoft Windows, Symbian, and Apple Mac operating systems.

The techniques may be implemented with machine readable storage media in a storage device included with or otherwise coupled or attached to a computing device 200. That is, the software may be stored in electronic, machine readable media. These storage media include, for example, magnetic media such as hard disks, optical media such as compact disks (CD-ROM and CD-RW) and digital versatile disks (DVD and DVD±RW), flash memory cards, and other storage media. As used herein, a storage device is a device that allows for reading and/or writing to a storage medium. Storage devices include hard disk drives, DVD drives, flash memory devices, and others.

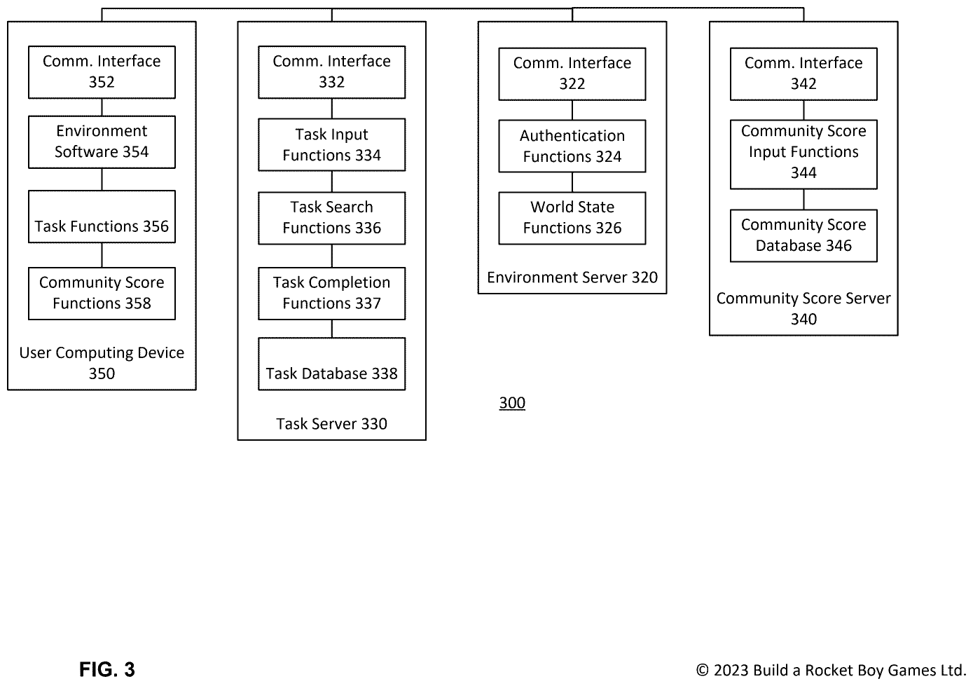

FIG. 3 is a functional block diagram of a system 300 for player-created tasks with a persistent community score. The system includes the environment server 320, the task server 330, the community score server 340, and the user computing device 350.

The environment server 320 includes a communications interface 322, authentication functions 334 and world state functions 336. The communications interface 322 is combined hardware and software functions that enable the environment server 320 to communication at a large scale with numerous connected users and other, related servers. The communications interface may include hardware protocols for data transmission and reception, as well as software protocols standard in internet connectivity. The communications interface 322 may rely upon custom protocols or data transmission standards or forms to enable the specific types and volume of data necessary for the environment server 320 to function.

The authentication functions 324 enable the environment server 320 to properly authenticate users and other servers that connect. This ensures that only authorized users access the user accounts associated with their avatar(s) and user created content, including interactive virtual environment components that the user has created and, in places where they are implemented, receives payment for user generated content visited or purchased or sold as a part of other user generated content. The authentication functions 324 may take various forms such as passwords and usernames, RSA keys, passkeys, shared public and private keys, fingerprint authentication or various other forms of authentication. In the case of servers connecting to the environment server 320, the authentication may be extremely secure and may rely upon shared encryption keys or the like or, access to a particular secure, shared API.

Finally, the world state functions 326 are an abstraction for the processes that the environment server 320 manages to ensure that the game world or interactive environment state is managed, maintained, updated, and shared for all connected users. The “state” is the present setting for all variables and elements making up the game world or interactive environment. These functions 326 include the locations of all player avatars for each user connected to the environment server 320, any scores or laps or kills or other metric for interactive elements of the game world or interactive environment, the state of any in-game or in-world door, portal, window, handle, ammo cache, weather state, music state, ownership of any in-game item or possession of any in-game item, and the like. This maintenance of state may require there to be conflict resolution for situations in which the state changes and is indeterminate for a moment or when errors occur, and requires selective communication of updates to the overall world state to users (e.g. only updating those users “near” an event that it's state has been updated, while leaving other user's out of the update to lower overall bandwidth usage). The world state functions 326 may also act as an arbiter of world state for all connected user computing devices, like user computing device 350. In cases where a present state conflicts between a given user computing device and the world state functions 326, the world state functions 326 govern.

The task server 330 includes a communications interface 332, task input functions 334, task search functions 336 and a task database 338. The communications interface 332 serves essentially the same functions as it does for the environment server 320. That discussion will not be repeated here.

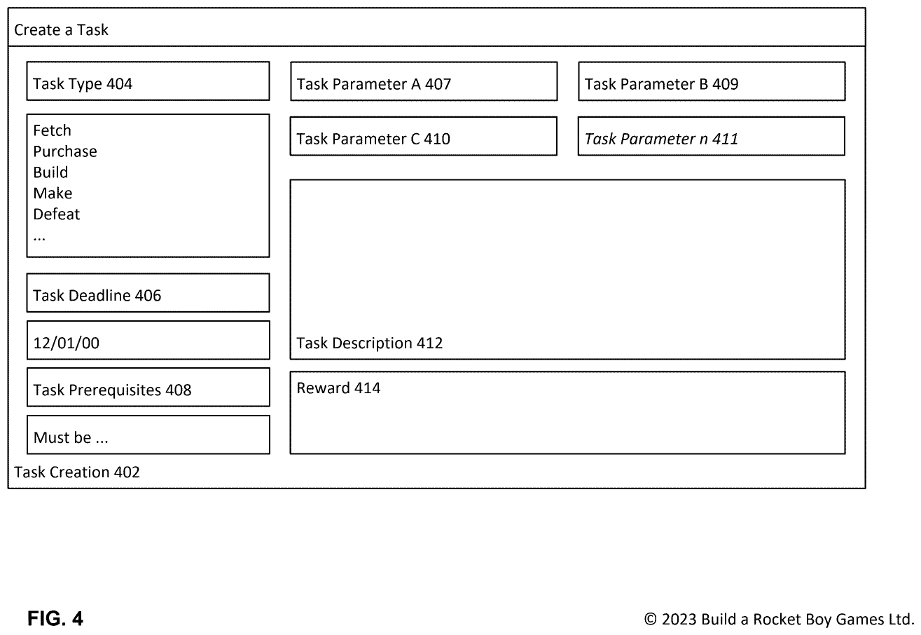

The task input functions 334 enable the receipt and storage of tasks from users. This process may be guided, using menus with limited functionality, or may be free-form, enabling users to effectively write programming code for the state that must be completed for the task to be considered complete. Preferably, to make the system accessible to a large number of people, the task input functions 334 are a series of menu-driven processes. An example of such a series of menu-driven processes are shown in FIGS. 4-9.

The task input functions 334 are intended to be flexible. A task requestor can design complex tasks, such as completing a virtual estate within the virtual world. The requestor can input values such as materials, style, overall size, a budget to purchase any necessary materials or digital locations. The task requestor can designate that the task may not be sub-contracted out or that it may. The task requestor can designate particular times or places where the task can or cannot be completed. Input of simple tasks is intended to be simple for users. But, the task input functions are intended to be as complex as necessary to adequately define a given task.

The task input functions 334 also enable the requestor to input the reward and, in some cases, to place the reward into escrow for completion of the task. In this way, the potential task candidates can see that the task requestor is serious and that the task requestor has the collateral for the requested task before it is accepted and undertaken.

The task input functions 334 are on the task server 330 because they are likely an API (application programming interface) to which a given user computing device, like user computing device 350, connects to add a task to the database. The task input functions 334 may operate to receive effectively a script that may be periodically run to check whether a given task is completed. The script may be generated by the task functions 356 on a given user computing device (discussed below). The task that is created may take the form of a series of case statements or if/then statements that, when completed, results in the reward being provided. The task's form is not particularly important, but its overall purpose is to provide a deterministic (e.g. the answer is either completed or not-completed) model for the task server 330 to follow to know that the task is completed, or not.

The task input functions 334 may include the capability to limit potential task candidates at the outset based upon any number of criteria. For example, the task input may include a requirement that any potential candidates have overall community scores over a certain threshold or that they have a specific community score (e.g. building ability, clothing design ability, reliability, wealth, character level, PvP level or ability, number of months or years in the system, a total number of ratings or community scores input). Likewise, a task requestor may input that a given task candidate must have completed a threshold number of a project type (e.g. bodyguard assignments, building assignments, design assignments, fetch assignments, etc.) before they may ask to be considered for a given task.

The task search functions 336 also likely operate as an API on the task server 330 to enable user computing devices, like the user computing device 350 to search for tasks to take on and accomplish. This may be merely searching all tasks (which are stored in the task database 338, discussed below) or searching according to some parameters. In this way, a potential task candidate may undertake a search of the task database 338 looking for tasks which they may accomplish. A builder of large estates may search for high-reward (e.g. large payouts) design opportunities or design opportunities that involve prestigious work (e.g. work for companies seeking to advertise in the environment or wealthy patrons within the environment). The user computing device may query the task search functions 336 on the task server 330 to find desirable opportunities for tasks. Those with less reputational history or success may search for tasks that they are able to do (e.g. ones that do not require any minimum community score(s) or ones with lower community score or past assignments completed thresholds).

The task completion functions 337 operate when the task has been completed or not completed by a threshold time limit on the task. The task completion functions 337 may operate to periodically, or when prompted by task candidate action, check on whether a given task's requirements have all been completed. The task completion functions 337 may trigger the transmission of the reward to the task completer and may also request one or more community scores, reviews, or other ratings from the task initiator regarding the task or the task completer. These functions may interact with the task database 338 and the community score database 346 to add new community scores, reviews or other information to the databases.

The task database 338 is a database operating on the task server 330 that stores all available tasks that may be accepted by potential task candidates. The task database 338 may also store past, completed tasks. A new task may be added the task database 338 using the task input functions 334. The task database 338 may be searched using the task search functions 336. Once a task is completed, the task database 338 may be updated to indicate as much and the task will no longer appear in live task search functions, but may be searchable using special tools or forms to search for completed tasks.

The community score server 340 includes a communications interface 342 much like that for the environment server 320 and the task server 330. That discussion will not be repeated here.

The community score input functions 344 enable users to input new community scores. As with the task input functions 334 and task search functions 336, these functions may operate as an API accepting the input of new data related to community scores for a given user or users related to tasks. The community score input functions 344 may operate in other situations—e.g. enabling people to simply input community scores when they interact with a given user, or enabling the input of community scores when a player engages in a game with another player, or entering community scores when a player purchases a product or design from another player, etc. However, one situation when the community score is input is after a task is completed (or not-completed) as determined by the task server 330.

The community score server 340 also includes the community score database 346. The community score database 346 stores data related to each user's community score(s). In some implementations, there may be a single score for the overall person. In other implementations, there may be a number of independent community scores for different purposes. The scores may relate to player attitude, skill, reliability, or to particular tasks such as engaging in game types, skill or ability designing or building buildings, or weapons or other objects within the game world.

The community score database 346 may be queried at will by any user for any other user or may only be available under certain circumstances (e.g. in the midst of a group combat mission, as a user peruses potential task candidates, etc.). A user may essentially “carry” their community score(s) with them wherever they go. A mouseover or “inspect” operation on a given user may pop up or otherwise provide one or more community scores to a viewer. This type of functionality is intended to mimic the real world where a person may be seen out and about and, if that person has a reputation in a given community, other people within that community typically are aware of that reputation.

The user computing device 350 includes a communications interface 352 which is substantially the same as those communications interfaces 322, 332, and 342 discussed above. That discussion will not be repeated here. The user computing device includes environment software 354 and task functions 356.

The environment software 354 is computer software that enables the user computing device 350 to connect to the environment server 320, to authenticate and to communicate state information to the environment server 320 to thereby interact with the game or interactive experience available on and hosted by the environment server 320. Typically, the environment software will be a game software, operating a game engine, and reliant upon game assets (models, textures, logic, and interfaces) stored locally on the user computing device 350. In some cases, the environment software 354 may rely upon real-time streaming of a pre-rendered game stream from a remote server (e.g. the environment server 320) operating to generate a video of the game or environment. Or, in for example VR experiences, a stream of an experience rendered on a local PC or computer. The overall result is that the environment software 354 enables a user to engage with the game and/or virtual environment.

The task functions 356 offer a user the opportunity to add tasks to the task database 338, to search for tasks to complete within the database 338, to confirm and review the status of a given task, and to provide reviews (e.g. community score(s)) for a task candidate who has completed a given task. Using these task functions 356, any user can interact with tasks, including creating, accepting, and completing a task.

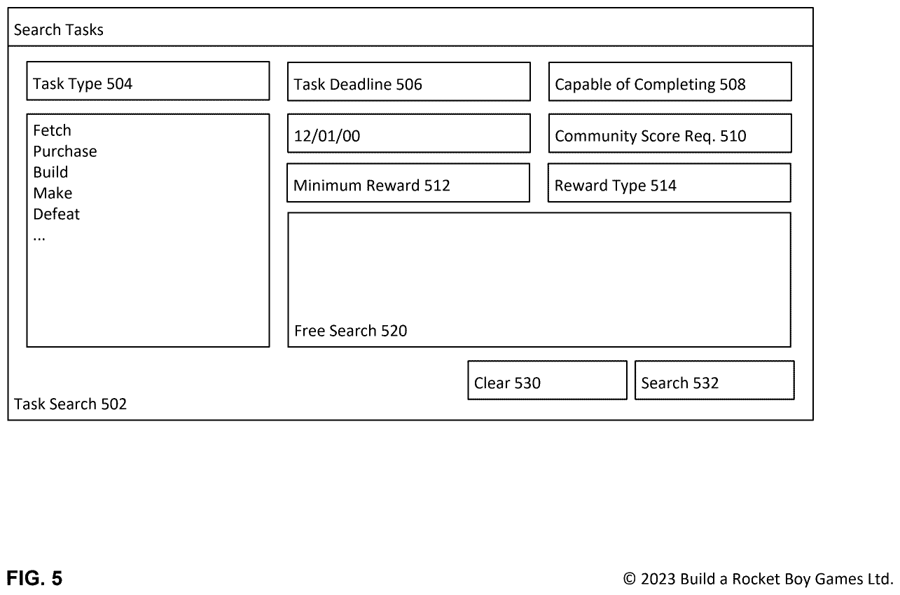

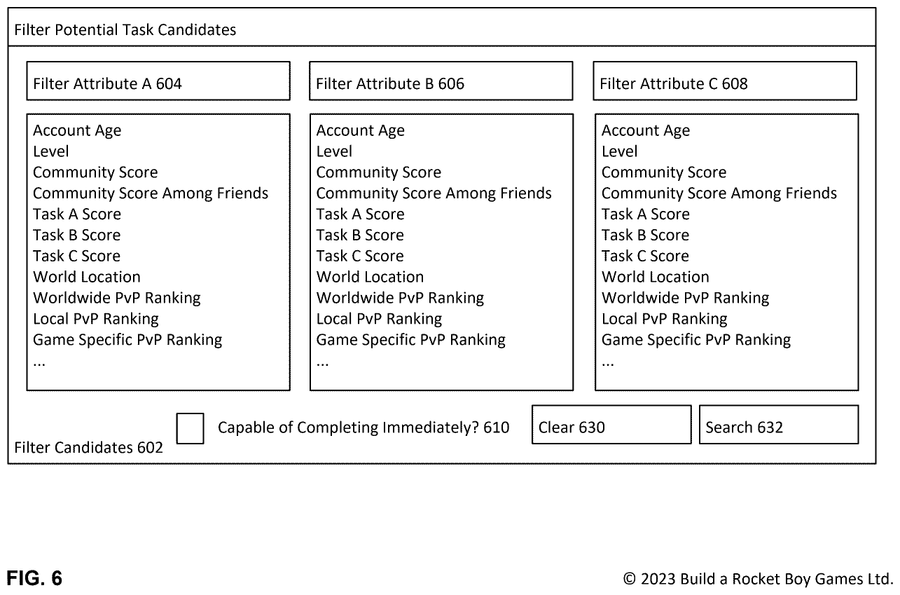

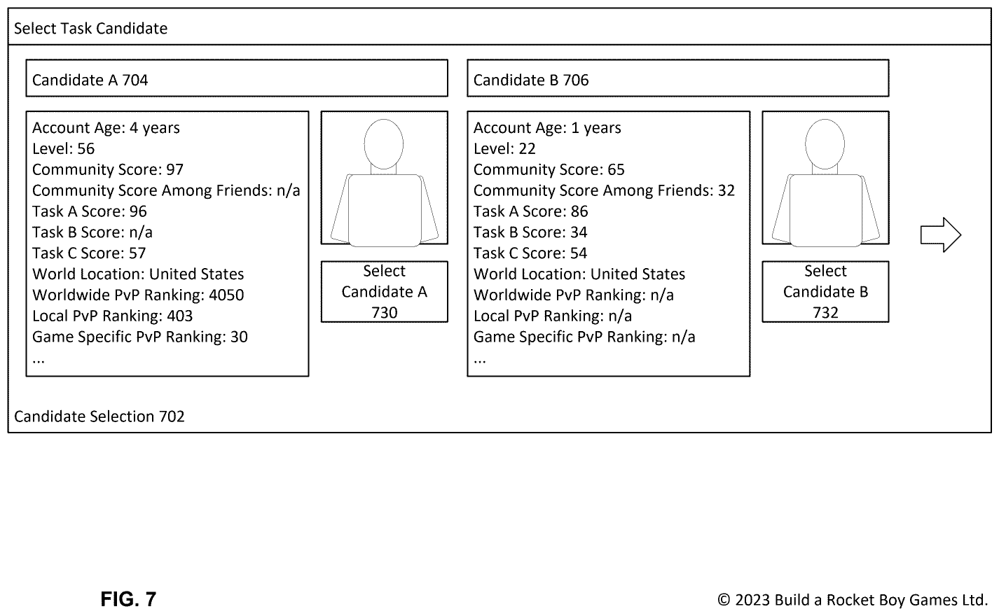

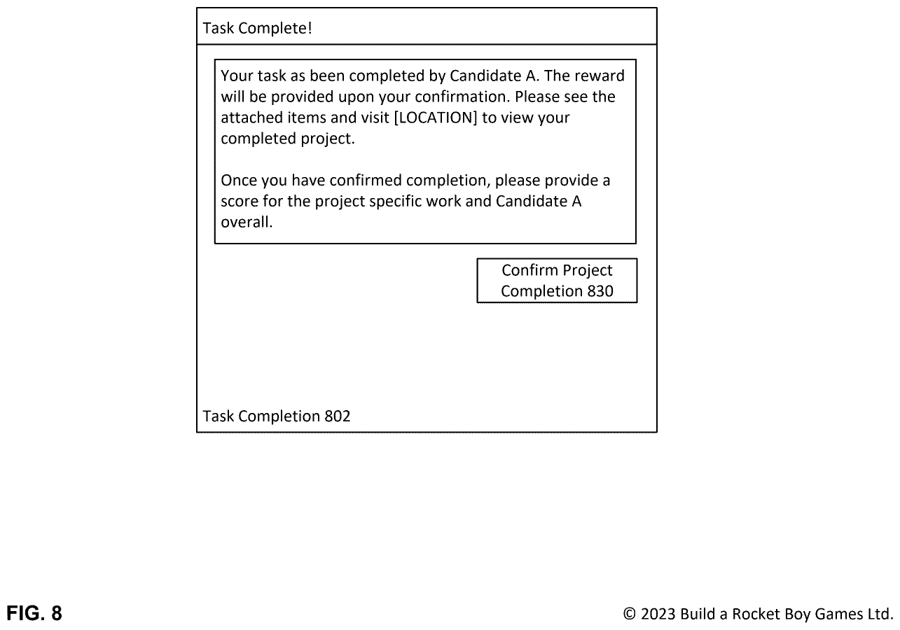

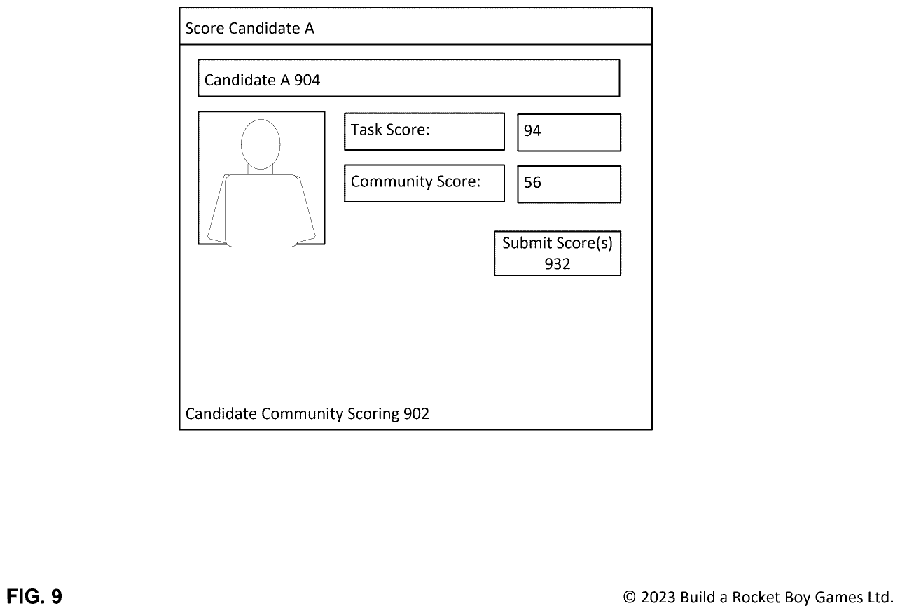

The task functions 356 may be presented as a series of menus, some examples of which are shown in FIGS. 4-9. FIG. 4 an example of a Task Creation menu. FIG. 5 is an example of a Task Eearch menu. FIG. 6 is an example of a Candidate Filter menu. FIG. 7 is an example of a Task Candidate Selection menu. FIG. 8 is an example of a Task Completion Notification. FIG. 9 is an example of a Task Candidate Score menu. These menus will be discussed in more detail subsequently.

The task functions 356 may be menus that pop up during gameplay, but also may be integrated into a game (e.g. shown on a wall within the three-dimensional environment, or at some other interface). The task functions may be integrated in a mixed way, for example, within the three-dimensional environment, a user may approach a terminal. Interacting with that terminal may cause the task functions to become visible or interactable. The user may search, input, interact with, cancel, or complete tasks within such a terminal or interface. There are various ways the task functions may be accomplished at a given user computing device 350.

The community score functions 358 are functions at the user computing device 350 used to request, capture, and transmit community scores of other users by the user of the user computing device 350. In addition, the community score functions 358 may perform functions related to community score presentation for the user of the user computing device. So, for example, the community score functions 358 may prompt a user to input a community score for another. See, e.g. FIG. 9. And, upon request, the community score functions 358 may present or provide information from the user to the community score server 340 related to the user's community score.

Description of Processes

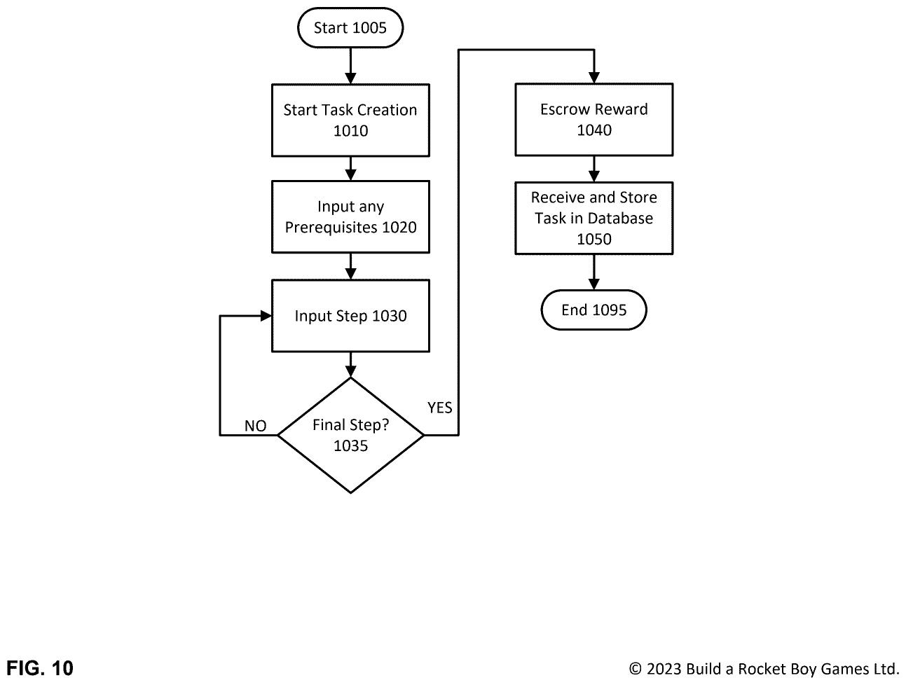

FIG. 10 is a flowchart of a process for creation of a new task. This process may be undertaken many times sequentially by a given user and simultaneously by different users.

Following the start 1005, the process begins with the start of task creation at 1010. Here, the user initiates the task creation process by launching menus within a game or environment software operating on a user computing device. Or, the user may approach a task input terminal within the three-dimensional environment. This process may be implemented by the task functions 356 discussed above. The process may have the appearance of FIG. 4 above, which depicts an example user interface for a task creation 402 process.

Using this interface, the user may input any prerequisites for the task at 1020. Here, the user may indicate that a potential task candidate must have a selected community score before they can undertake this task. Or, that the user must be of a certain level, a specific community score (e.g. be well-reviewed at a specific task), or have a certain prerequisite number of similar tasks already completed with a certain level of ratings related to those tasks. The requestor may also input a task type 404 and a task deadline 406 at this step, selecting a sub-set of task types and a deadline by which the task must be completed.

This is shown in task prerequisites 408 in FIG. 4. These may be very free form. These parameters may be related to the task itself (e.g. fetch 10 moth wings) or may be related to prerequisites discussed above. The user may input as many of these as they desire for a given task.

Returning to FIG. 10, the user may next input a step at 1030. This is called a step, because tasks may have a series of elements to complete (ordered or non-ordered), but it may be considered an element of the task or a sub-part of a given task or it may be the entire task (e.g. build a home). The designer of the task can frame the task however they wish.

In FIG. 4, there are shown a series of task parameters A, B, C and n 407, 409, 410, 411. These may be the steps or elements of a given task. The user may input as many steps as desired or as necessary to accomplish a given task. The reward will presumably—due to pressures of a market economy—be commensurate with the task or the level of desire of the user to have the task done well.

The user may also input a task description 412 to describe the overall task. Here, the user may wish to describe the clothing desired, suggest locations to capture or purchase required items, or provide some description of a desired home or estate within the game world.

Once a given step (e.g. fetch materials to build a home of a certain size) is input, then a determination is made whether this is the final step in the task at 1035. If not (“no” at 1035), then the process continues with the input of another step at 1030.

If this is the final step of the task (“yes” at 1035), then the process continues with escrow of the reward at 1040. Here, the user may input the reward. Preferably, the reward will be drag-and-drop from a user's inventory into reward box 414 in FIG. 4. Alternatively, a user may input an amount of currency or some other reward. It is preferable to escrow the reward so that astronomical rewards that a given user can never pay or provide will not be offered for tasks, undermining the economy of the tasks.

Once the reward has been escrowed or otherwise identified at 1040, the overall task with its prerequisites, steps, description, and reward are received and stored in the task database at 1050. The task will then be searchable and may be undertaken by a selected task candidate (discussed below).

Thereafter, the process ends at 1095.

FIG. 5 shows an example user interface for a task search 502 process. A potential task candidate may search for potential tasks to be accomplished in order to earn some money, or to obtain a specific reward. The user may search on any number of elements, such as task type 504. Examples of fetch tasks, purchase tasks, build tasks, make takes (e.g. an item or furniture or clothing), and defeat (e.g. a particular level, boss, or character) are shown. Numerous other types of tasks could be searched. A given user may wish to participate in a particular type of task or may be better-suited to a particular type of task, such a filter on task type may be desirable for that purpose.

The user may also search on the task's deadline 506, whether the user is capable of completing the task 508 (e.g. has the required level, or otherwise has materials available). The user may search on any community score requirements 510 to only show tasks which the user is able to undertake.

The user may search on minimum reward 512 (e.g. of a minimum value) or a reward type 514 (e.g. money, NFT, crypto, in-game items, etc.). A given searcher may wish to only seek certain rewards or reward types or only perform a task if the reward is large enough.

The user may free search to type in keywords or other information which may be desirable or form the basis of a given task at 520. This search may include the description of the task or any keywords associated with the task.

The user may clear the search parameters at 530 or perform the search at 532.

This is only an example interface, and variances are likely without changing the overall function.

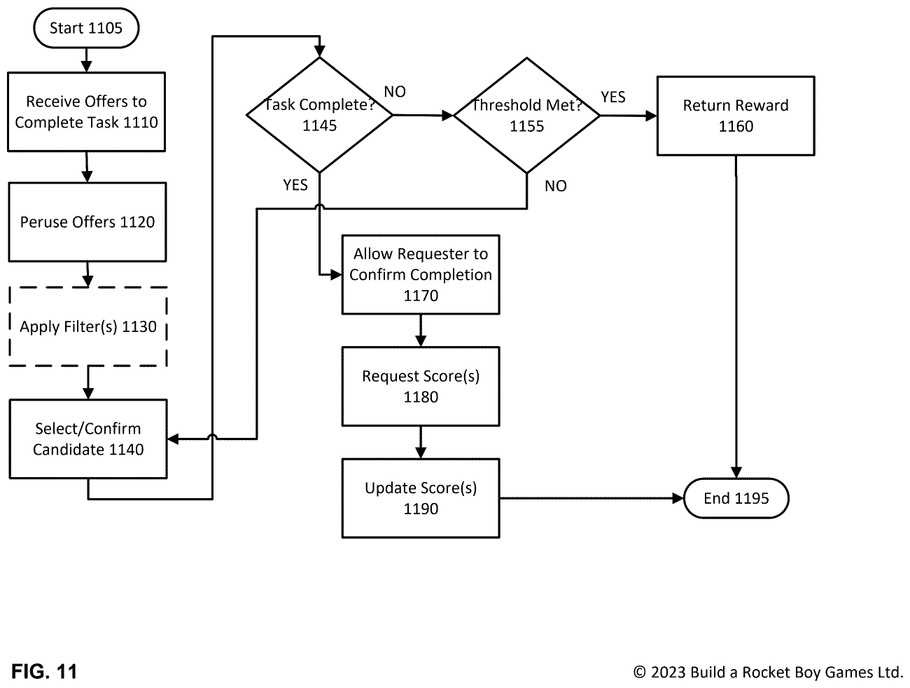

Turning now to FIG. 11, a flow diagram for a process of selection of a task candidate and completion of the task is shown. The process has a start at 1105 and an end at 1195. The process may repeat many times over for any number of tasks.

Following the start 1105, the process begins at 1110 with receipt of offers to complete a given task. Here, the task server 330 may note that a number of prospective task candidates have indicated a willingness to undertake a given task. Those offers may be stored in the task database 338.

Once a user requesting the task has time or is available, the offers that have been received may be perused at 1120.

However, in some cases, the overall number of offers may be overwhelming, or a task requester may wish to limit the options for potential candidates. In such case, a filter may be desirable to apply at 1130 (this step is optional). FIG. 6 is an example user interface for a task candidate filtering 602 process. Here, a series of filter attributes A, B, and C 604, 606, and 608 are shown. The task requester may filter the listing of potential candidates who have offered to complete the task based upon any number of attributes. A series of attributes are shown in FIG. 6.

The user may also check a box indicating that they would like the ability to immediately complete at 610. This may mean that the task candidate has the items already in their inventory that are necessary for the task, or already has a completed build order or clothing or other item ready. The potential task candidate may indicate this in response to the task request or the task server 330 may check to confirm that this is the case to enable this filter automatically.

The user may clear the filter attributes 630 or search on them 632 to apply the filter.

Returning to FIG. 11, after the filter is applied at 1130 or while perusing the candidates at 1120, the candidates are selected at 1140. FIG. 7 is an example user interface for a selection of a task candidate 702. A series of candidates A and B 704, 706 are shown. The user may peruse the attributes of the two candidates, which may be listed nearby, and may select candidate A 730, select candidate B 732, or may continue looking at other candidates by sliding the user interface to the left.

Once selected, the task requester awaits completion of the task.

A determination is made whether the task has been completed at 1145. This may take place periodically (e.g. every few minutes or seconds) or may be triggered by action of the selected task candidate. So long as the task is not completed (“no” at 1145), a second determination is made whether a threshold time has been met for the task to be completed at 1155. Here, a determination is made whether too much time has been elapsed for the task. A user may set a deadline for the task. If that deadline is not met (“no” at 1155), then the candidate may be confirmed at 1140. If the threshold has been met (“yes” at 1155), then the reward offered by the task requester may be returned at 1160 and the process may end at 1195. The task requester may reinitiate their desired task or may not do so.

If the task is completed (“yes” at 1145), then the requester may confirm completion at 1170. FIG. 8 is an example user interface for a task completion 802. Here, a notice is provided to the task requester indicating that the task is complete. The user may have opportunity to check on the status of the task (e.g. is the home built to a desired specification, are the items in their inventory, etc.). Once confirmed, the user may select confirm project completion at 830 to confirm. This corresponds to step 1170 above.

Next, the system may request score(s) from the project requester at 1180. These requests help to fuel the overall community score system to enable it to continue to function accurately. FIG. 9 is an example user interface for candidate community scoring 902. Here, Candidate A 904 is being scored on the specific task and the overall community score. The requester can submit the scores by pressing the button 932.

Returning to FIG. 11, the scores are then updated at 1190. When this happens, the scores are added to the community score database 346. Smoothing algorithms, and review-bombing prevention algorithms may be applied to ensure that outlier scores do not dramatically alter a given user's community score.

Thereafter, the process ends at 1195.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for selecting an individual to accomplish a player-created task within a three-dimensional environment, the system comprising a computing device configured to:
accept the creation of a task on behalf of a user within the three-dimensional environment from a client computing device, the task including a reward to be provided within the three-dimensional environment;
receive and store the task to a database of available tasks within the three-dimensional environment;
transmit a listing of a plurality of potential task candidates to the client computing device, the listing of the plurality of potential task candidates who have offered to accomplish the task and at least one community score for each of the plurality of potential task candidates; and
receive a selection of the individual from the plurality of potential task candidates from the client computing device, the selection at least in part reliant upon the at least one community score.

2. The system of claim 1 wherein the computing device is further configured to:
receive a search request within the listing of a plurality of potential task candidates; and
transmit a subset of the plurality of potential task candidates to the client computing device in response to the search request, the subset matching search criteria within the search request.

3. The system of claim 1 wherein:
the creation of the task defines a plurality of steps within a user interface that enables a deterministic result regarding whether and when the task has been completed;
the computing device is further configured to:
confirm completion of the task based upon the deterministic result regarding the plurality of steps; and
provide the reward to the individual that completed the task.

4. The system of claim 3 wherein the user must pledge the reward, placing it in the care of the computing device until the task is completed or a predetermined time has elapsed without completion of the task.

5. The system of claim 1 wherein, upon completion of the task, the computing device is further configured to:
receive at least one score related to the task from the client computing device; and
incorporate the at least one score into data making up the at least one community score.

6. The system of claim 1 wherein the at least one community score comprises at least two scores, namely:
an overall score for a generally positive reputation within the three-dimensional environment; and
a task-specific score for a particular type of task, the task-specific score including an indication of a given one of the plurality of potential task candidates ability with respect to at least one specific task type.

7. The system of claim 6 wherein the overall score is generated in part based upon voluntary ratings of a given one of the plurality of potential task candidates by other players within the three-dimensional environment over time.

8. The system of claim 6 wherein the user may input a desire to exclude a selected one of: (a) all potential task candidates with no task-specific score related to the task, and (b) all potential task candidates wherein the task specific score related to the task falls below a selected threshold.

9. The system of claim 1 wherein the plurality of potential task candidates are required to have reviewed any requirements associated with the task prior to offering to accomplish the task.

10. The system of claim 1 wherein the task is a multi-step task and the computing device is further configured to accept the input of a plurality of ordered or non-ordered steps to accomplish the task, the plurality of ordered or non-ordered steps input by the user using the client computing device.

11. A system for selecting an individual to accomplish a player-created task within a three-dimensional environment, the system comprising a computing device configured to:
create a task for the individual within the three-dimensional environment;
post the task to a database of available tasks within the three-dimensional environment on a server computing device;
retrieve a listing of a plurality of potential task candidates from the separate computing device, the listing of the plurality of potential task candidates who have offered to accomplish the task and at least one community score for each of the plurality of potential task candidates; and
select one of the plurality of potential task candidates reliant, at least in part, upon the at least one community score.

12. The system of claim 11 wherein the computing device is further configured to:
perform a search within the listing of a plurality of potential task candidates; and
report a subset of the plurality of potential task candidates in response to the search request, the subset matching search criteria within the search request.

13. The system of claim 11 wherein:
the creation of the task defines a plurality of steps within a user interface of the computing device that enables a deterministic result regarding whether and when the task has been completed; and
the computing device must accept a pledge of the reward during the creation of the task until the task is completed or a predetermined time has elapsed without completion of the task; and
once it is determined that the task has been completed, the reward is provided to the individual that completed the task.

14. The system of claim 11 wherein, upon completion of the task, the computing device is further configured to:
receive at least one score related to the task from the client computing device; and
transmit the at least one score to the server computing device incorporate the at least one score into data making up the at least one community score.

15. The system of claim 11 wherein the at least one community score comprises at least two scores, namely:
an overall score for a generally positive reputation within the three-dimensional environment; and
a task-specific score for a particular type of task, the task-specific score including an indication of a given one of the plurality of potential task candidates ability with respect to at least one specific task type.

16. The system of claim 15 wherein the overall score is generated in part based upon voluntary ratings of a given one of the plurality of potential task candidates by other players within the three-dimensional environment over time.

17. The system of claim 15 wherein the user may input a desire to exclude a selected one of: (a) all potential task candidates with no task-specific score related to the task, and (b) all potential task candidates wherein the task specific score related to the task falls below a selected threshold.

18. The system of claim 11 wherein the plurality of potential task candidates are required to have reviewed any requirements associated with the task prior to offering to accomplish the task.

19. The system of claim 11 wherein the task is a multi-step task and the computing device is further configured to accept the input of a plurality of ordered or non-ordered steps to accomplish the task, the plurality of ordered or non-ordered steps input by the user using the computing device.

20. A system for selecting an individual to accomplish a player-created task within a three-dimensional environment, the system comprising a computing device configured to:
accept the creation of a task on behalf of a user within the three-dimensional environment from the user using a client computing device, the task including:
a plurality of steps that must be accomplished by the individual for the task to be completed;
a requirement of at least one community score meeting a user-selected threshold to accept the task; and
a reward to be provided within the three-dimensional environment upon completion of the plurality of steps in the task by the individual;
receive and store the task to a database of available tasks within the three-dimensional environment;
transmit the task to at least one potential task candidate;
receive at least one offer to complete the task from one of the at least one potential task candidate;
transmit a listing of a plurality of potential task candidates to the client computing device, the listing being the plurality of potential task candidates who have offered to complete the task and at least one community score for each of the plurality of potential task candidates; and
receive a selection of one of the plurality of potential task candidates from the client computing device, the selection at least in part reliant upon the at least one community score.
